(19) United States
(12) Patent Application Publication
(10) Pub. No.: US 2010/0154410 A1
(43) Pub. Date: Jun. 24, 2010

(54) INTEGRAL MULTIFUNCTIONAL SYSTEM FOR MOTOR VEHICLE

(76) Inventor: Galin Raychinov, Sofie (BG)

Correspondence Address: NEXSEN PRUET, LLC, P.O. BOX 10648, GREENVILLE, SC, 29603, US

(21) Appl. No.: 12/376,392

(22) PCT Filed: Aug. 2, 2007
(86) PCT No.: PCT/BG2007/000016

§ 371 Date: Feb. 4, 2009

(30) Foreign Application Priority Data
Aug. 4, 2006 (BG) 109643

(51) Int. Cl. B60K 6/12

(52) U.S. Cl. 60/597

(57) ABSTRACT

Integral multifunctional system for motor vehicle including a gas turbine (1) mounted on the exhaust pipe of the internal combustion engine (2) of the vehicle and mechanically coupled to a hydraulic pump (3), featuring also a serial hybrid hydraulic system (4), wherein the inlet of the hydraulic pump (3) is connected to the low pressure tank (5) of the serial hybrid hydraulic system (4) and the outlet of the hydraulic pump (3) is connected to the high pressure hydraulic accumulator (6) of the serial hybrid hydraulic system (4).

### TECHNICAL FIELD

The present invention pertains to an integral multifunctional system for motor vehicle and finds application mainly in manufacture and use of cars, industrial trucks, rail and other transport vehicles.

### PRIOR ART

There is a Bulgarian patent N^{o} BG 63128 referring to an integral multifunctional system for motor vehicle. The system essentially represents a synergy of a so-called parallel hybrid hydraulic system coupled additionally to a hydraulic pump, the latter connected via a reducing gear or directly to a gas turbine mounted on the exhaust pipe of an internal combustion engine, featuring additional hydraulic links between the high pressure hydraulic accumulator and the low pressure hydraulic tank to at least one auxiliary hydraulic mechanism of the vehicle. In this way, the system provides recovery of the kinetic energy of the vehicle when the latter decelerates or comes to a halt, recovery of the energy of exhaust gases released by the internal combustion engine of the vehicle, as well as supply of pressurized hydraulic fluid to the auxiliary hydraulic mechanism and collection of the spent hydraulic fluid leaving the said mechanism.

The described integral multifunctional system for motor vehicle has one major drawback. The hydraulic hybrid system incorporated in the system is a parallel type imposing the need for a simultaneous use of a parallel transmission of a different known type, such as mechanical multispeed or automatic hydrodynamic etc. transmission, on the vehicle, which makes the vehicle more sophisticated and expensive as a whole and limits the transmission ratio adjustment range to the maximum ratio achievable by the known transmission being used.

### SUMMARY OF THE INVENTION

The purpose of the invention is to design an integral multifunctional system for motor vehicle capable of enhancing the energy efficiency by making the transport vehicle simpler and less expensive.

The purpose of the invention can be achieved by an integral multifunctional system for motor vehicle including a gas turbine mounted on the exhaust pipe of the internal combustion engine of the vehicle and mechanically coupled to a hydraulic pump. The system features a serial hybrid hydraulic system, wherein the hydraulic pump inlet is connected to the low pressure tank of the serial hybrid hydraulic system and the hydraulic pump outlet is connected to the high pressure hydraulic accumulator of the serial hybrid hydraulic system.

One of the feasible designs of the system provides for incorporating a serial mechanical link between the gas turbine and the hydraulic pump used to synchronize the working rotational speed of the gas turbine with that of the hydraulic pump.

Another feasible design of the system provides for incorporating a fitting linking the high pressure hydraulic accumulator of the serial hybrid hydraulic system with the inlet of at least one auxiliary hydraulic mechanism, as well as a second fitting linking the outlet of the auxiliary hydraulic mechanism/mechanisms with the low pressure hydraulic tank of the serial hybrid hydraulic system.

A preferable design of the system according to any of the first three claims provides for using a hydraulic pump with adjustable flow rate, whose flow rate adjusting mechanism is connected to the electronic control unit of the serial hybrid hydraulic system.

In combination with the previous option, the system features exhaust gas pressure and/or flow rate sensors positioned upstream and downstream of the gas turbine, respectively, both of which are connected to the electronic control unit of the serial hybrid hydraulic system.

The system under the invention provides the following advantages:

Enhanced energy efficiency due to the extended range of engine/drive wheel transmission ratios achieved by the serial hybrid hydraulic system. Enhancing the energy efficiency of the system can also be achieved by recovering the kinetic energy of a decelerating vehicle and recovering the energy of exhaust gases leaving the internal combustion engine, as well as by feeding pressurized hydraulic fluid to the auxiliary hydraulic mechanisms of the vehicle and collecting the spent hydraulic fluid leaving the mechanisms.

Another advantage is that the vehicle is less sophisticated and expensive as a whole by avoiding the use of additional parallel transmission. The same effect is obtained also due to not using of hydraulic pumps for feeding pressurized hydraulic fluid to the auxiliary hydraulic mechanisms of the vehicle and collecting the spent hydraulic fluid leaving the said mechanisms.

### DESCRIPTION OF THE ATTACHED DRAWINGS

FIG. 1 illustrates the operating principle of the system under the invention according to its basic option.

FIG. 2 illustrates the operating principle of the system under the invention according to one of the existing options.

### EXAMPLES FOR EMBODIMENT OF THE INVENTION

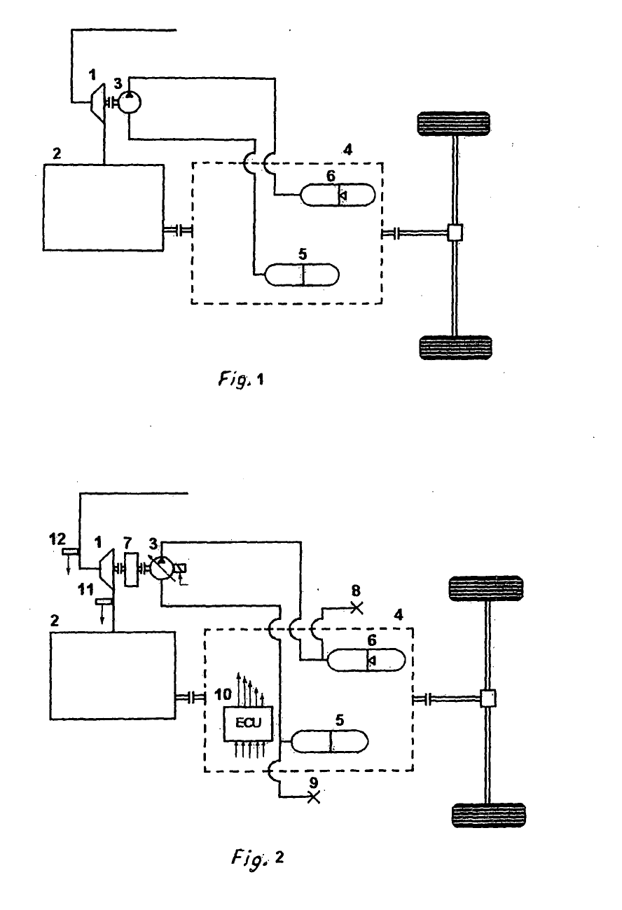

FIG. 1 shows a preferable design option, wherein the system features a gas turbine 1 mounted on the exhaust pipe 2 of the internal combustion engine of the vehicle and mechanically coupled to a hydraulic pump 3. The inlet of the latter has a hydraulic connection with the low pressure tank 5 of the serial hybrid hydraulic system 4. The latter is one of the known types, such as those described in paper N^{o} EPA420-F-04-019 posted on the following website: http://www.epa.doviotaa/technology/420f04019.pdf, or the paper Hydraulic Hybrids delivered on 22.03.2006 at the Michigan Clean Fleet Conference, both papers presented on behalf of the Environment Protection Agency—EPA, or the serial hybrid hydraulic system described on the following website: http://www.greencarcongress.com/2005/02/epa_eaton_and_p.html The outlet of the hydraulic pump 3 has a hydraulic connection with the high pressure hydraulic accumulator 6 of the serial hybrid hydraulic system 4.

The system operates as follows:

The vehicle as a whole and its internal combustion engine and serial hybrid hydraulic system operate in the conventional way. At the same time, the exhaust gases leaving the internal combustion engine 2 of the vehicle propel the gas turbine 1 driving in turn the hydraulic pump 3. The latter pumps the hydraulic fluid out of the low pressure tank 5 of the serial hybrid hydraulic system 4 and feeds the hydraulic fluid in question to the high pressure hydraulic accumulator 6 of the serial hybrid hydraulic system 4. In this way, the energy of exhaust gases leaving the internal combustion engine of the vehicle is transformed into potential high pressure hydraulic fluid energy in the hydraulic accumulator 6 of the serial hybrid hydraulic system 4 of the vehicle. At a later stage (or simultaneously with the accumulation, depending on the operational mode of the vehicle), the energy of exhaust gases leaving the internal combustion engine 2 so far transformed into potential hydraulic energy is transformed by the serial hybrid hydraulic system 4 into additional mechanical power to be used in accelerating the vehicle and/or sustaining the steady speed movement of the vehicle. The power consumption of the internal combustion engine for the operational mode in question decreases and, as a result, the fuel consumption decreases and the vehicle energy efficiency increases. Transforming the energy of exhaust gases leaving the internal combustion engine 2 into potential hydraulic energy in the high pressure hydraulic accumulator 6 of the serial hybrid hydraulic system 4 and its subsequent or simultaneous transformation into additional mechanical power eliminates the direct mechanical link between the gas turbine 1 and the internal combustion engine 2 or the vehicle driving wheels. This provides an opportunity for the gas turbine 1 to be operated at a rotational speed independent from that of the internal combustion engine 2 or that of the vehicle driving wheels. On the other hand, the high pressure hydraulic accumulator 6 also functions as a damper for the differences between the discrete angle speeds of the gas turbine 1 and the internal combustion engine 2 or the vehicle driving wheels, the said damper sustaining no losses caused by mechanical or hydraulic friction. Owing to the latter two circumstances, the described integral multifunctional system for motor vehicle provides an increased efficiency in transforming the energy of exhaust gases leaving the internal combustion engine into additional mechanical power being fed to the vehicle driving wheels.

The described preferable design of the integral multifunctional system for motor vehicle may include optionally a mechanical reducing gear 7 installed in series between the gas turbine and the hydraulic pump and used to decrease the rotational speed as a way of synchronizing the working rotational speed of the gas turbine 1 with that of the hydraulic pump 3.

This system design operates in a similar way to the previously described design except for the fact that the reducing gear 7 synchronizes the difference between the rotational speed of the gas turbine 1 and that of the hydraulic pump 3 by decreasing the rotational speed and increasing the torque imparted by the gas turbine 1 to the hydraulic pump 3.

Another preferable design of the serial integral multifunctional system for motor vehicle features a fitting 8 linking the high pressure hydraulic accumulator 6 with the serial hybrid hydraulic system 4 and the inlet of at least one auxiliary hydraulic mechanism, as well as a fitting 9 linking the outlet of the auxiliary hydraulic mechanism/mechanisms with the low pressure hydraulic tank 5 of the serial hybrid hydraulic system 4.

The system so described operates similarly to the previously described designs while providing additionally for feeding high pressure hydraulic fluid via fittings 8 and 9 to at least one auxiliary hydraulic mechanism of the vehicle, as well as collecting the spent hydraulic fluid leaving the mechanism/mechanisms in question.

The fourth preferable design of the serial integral multifunctional system for motor vehicle uses a hydraulic pump 3 with adjustable flow rate, whose flow rate adjusting mechanism is connected to the electronic control unit of the serial hybrid hydraulic system.

This system design operates in a similar way to the previously described designs except for the fact that the electronic control unit 10 of the serial hybrid hydraulic system 4 provides control for the hydraulic pump 3 flow rate thus controlling the additional power derived from the exhaust gases leaving the internal combustion engine in accordance with a program incorporated in the electronic control unit 10 of the serial hybrid hydraulic system 4 taking account of the readings displayed by the sensors of the serial hybrid hydraulic system 4, e.g. sensors monitoring the rotational speed and load of the internal combustion engine 2, desired power (selectable to by changing the gas pedal position), pressure in the high pressure hydraulic accumulator 6 etc. The adjustment of the hydraulic pump 3 operation achieved in this way and the resulting adjustment of the derived exhaust gas power and that of the exhaust gas back pressure contribute to enhancing the overall energy efficiency of the internal combustion engine 2/gas turbine 1 assembly by synchronizing their operation and preventing possible internal combustion engine 2 power and energy efficiency decreases due to potentially excessive exhaust gas back pressure within the exhaust pipe of the internal combustion engine 2.

Another preferable design of the serial integral multifunctional system for motor vehicle (FIG. 2) features pressure and/or flow rate sensors 11 and 12 for the exhaust gases leaving the internal combustion engine 2, positioned upstream and downstream of the gas turbine, respectively, and connected to the electronic control unit 10 of the serial hybrid hydraulic system 4.

This system design operates in a similar way to the previously described design except for the fact that the program of the electronic control unit 10 of the serial hybrid hydraulic system 4 refers to factors such as the pressure and/or flow rate readings for the exhaust gases leaving the internal combustion engine 2 taken upstream and downstream of the gas turbine 1, respectively. Reading these values enables the program of the electronic control unit 10 to carry out control of the hydraulic pump 3 flow rate and, by doing so, of the braking moment and rotational speed of the gas turbine and of the back pressure of exhaust gases leaving the internal combustion engine 2 with view to achieving maximum gas turbine 1 power and efficiency for each operational mode of the internal combustion engine 2 without deteriorating the performance of the latter, or while entailing a deterioration significantly inferior to the gains in additional power and efficiency generated by the gas turbine 1.

1. Integral multifunctional system for motor vehicle including a gas turbine (1) mounted on the exhaust pipe of the internal combustion engine (2) of the vehicle and mechanically coupled to a hydraulic pump (3), featuring also a serial hybrid hydraulic system (4), wherein the inlet of the hydraulic pump (3) is connected to the low pressure tank (5) of the serial hybrid hydraulic system (4) and the outlet of the hydraulic pump (3) is connected to the high pressure hydraulic accumulator (6) of the serial hybrid hydraulic system (4), and wherein the gas turbine (1) is linked in series by a mechanical link (7) to the hydraulic pump (3) instead of in parallel to the engine (2).

2. Integral multifunctional system for motor vehicle according to claim 1 wherein said mechanical link (7) which synchronizes the working rotational speed of the gas turbine (1) with that of the hydraulic pump (3).

3. Integral multifunctional system for motor vehicle according to claim 1 featuring a fitting (8) linking the high pressure hydraulic accumulator (6) of the serial hybrid hydraulic system (4) with the inlet of at least one auxiliary hydraulic mechanism, as well as a fitting (9) linking the outlet of the auxiliary hydraulic mechanism/mechanisms with the low pressure hydraulic tank (5) of the serial hybrid hydraulic system (4).

4. Integral multifunctional system for motor vehicle according to claim 1 to featuring a hydraulic pump (3) with adjustable flow rate, whose flow rate adjusting mechanism is connected to the electronic control unit (10) of the serial hybrid hydraulic system (4).

5. Integral multifunctional system for motor vehicle according to claim 4 featuring an exhaust gas pressure and/or flow rate sensor (11) positioned upstream of the gas turbine (1) and an exhaust gas pressure and/or flow rate sensor (12) positioned downstream of the gas turbine (1), wherein both sensors (11) and (12) are connected to the electronic control unit (10) of the serial hybrid hydraulic system (4).
